(19) United States
(12) Patent Application Publication
(10) Pub. No.: US 2009/0034104 A1
(43) Pub. Date: Feb. 5, 2009

(54) COLOR WHEEL

(75) Inventor: YU-LUN HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/940,925

(22) Filed: Nov. 15, 2007

(30) Foreign Application Priority Data
Jul. 30, 2007 (CN) 200710201211.1

(51) Int. Cl. G02B 7/00

(52) U.S. Cl. 359/892; 359/891; 359/889

(57) ABSTRACT

An exemplary color wheel includes a motor, a carrier, a color filter unit, and a fixing member. The carrier includes a main body fixed to the motor and a tapered spindle extending from the main body and away from the motor. The tapered spindle defines an axial hole therein. The color filter unit defines an opening at a central portion thereof. The opening is shaped as but smaller than the tapered spindle and receives a portion of the tapered spindle. The fixing member includes a head pressing on the color filter unit and a shank extending from the head. The shank is engaged in the axial hole of the tapered spindle.

### BACKGROUND

1. Technical Field

The present invention relates to color wheels and, particularly, to a color wheel for use in projection technology.

2. Description of Related Art

A color wheel for a projection device includes a color filter which is rotated at high speed by a motor for the separation of colors from a white light passing therethrough. The separated colors are then processed by another optical element of the projection device to produce a full color image.

Generally, a conventional color wheel comprises a carrier, a color filter, a motor, and a cover. The color filter is fixed to the carrier by adhesive, wherein the carrier is fixed to a shaft at the center of the motor by means of the cover. The motor rotates the carrier and the color filter around a central axis via the shaft of the motor.

As above-mentioned, the color filter is fixed to the carrier by adhesive, however, the mass of adhesive is difficult to control due to the flow property thereof such that the color wheel is unbalanced. Moreover, rotational instability and vibration may occur due to unbalanced mass distribution of the color wheel. Furthermore, the color filter comprises a plurality of fan-shaped filter segments adhered to each other; hence, precise positioning thereof is difficult and the segments may be separated during rotation at high speed.

What is needed, therefore, is a color wheel which is precisely assembled and can have a balanced rotation.

### SUMMARY

In accordance with a present embodiment, a color wheel includes a motor, a carrier, a color filter unit, and a fixing member. The carrier includes a main body fixed to the motor and a tapered spindle extending from the main body and away from the motor. The tapered spindle defines an axial hole therein. The color filter unit defines an opening at a central portion thereof. The opening is shaped as but smaller than the tapered spindle and receives a portion of the tapered spindle. The fixing member includes a head pressing on the color filter unit and a shank extending from the head. The shank is engaged in the axial hole of the tapered spindle.

Other advantages and novel features will be drawn from the following detailed description of at least one preferred embodiment, when considered in conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic, cross-sectional view of a color wheel, according to a first present embodiment.

FIG. 2 is a schematic, cross-sectional view of a color wheel, according to a second present embodiment.

FIG. 3 is a schematic, cross-sectional view of a color wheel, according to a third present embodiment.

### DETAILED DESCRIPTION OF THE PREFERRED EMBODIMENTS

Embodiments of the present color wheel will now be described in detail below and with reference to the drawings.

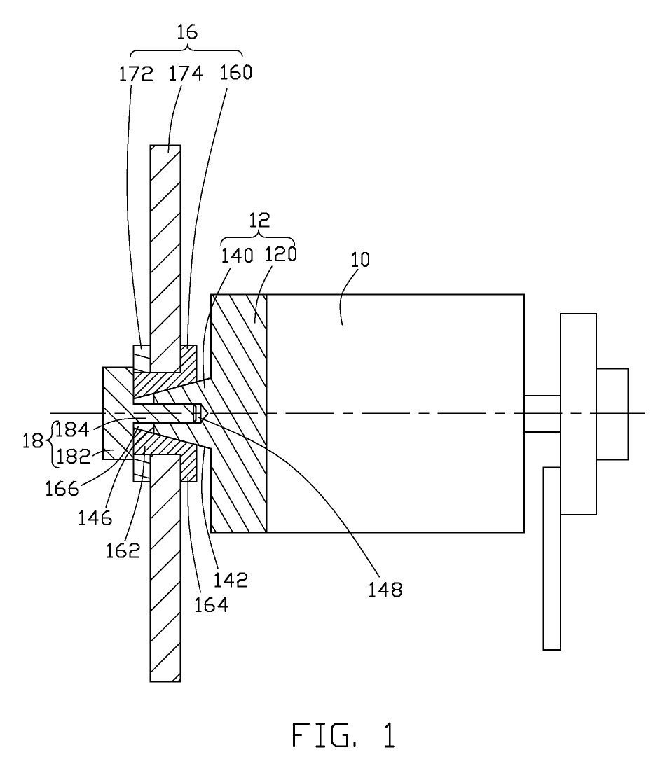

Referring to FIG. 1, a color wheel in accordance with a first present embodiment comprises a driving unit such as a motor 10, a carrier 12, a color filter unit 16, and a fixing member 18. The carrier 12 is fixed to a shaft (not shown) of the motor 10. The color filter unit 16 is positioned to the carrier 12 by means of the fixing member 18. The motor 10 rotates the carrier 12 and the color filter unit 16 around a central axis of the motor 10 via the shaft of the motor 10.

The carrier 12 comprises a main body 120 fixed to the shaft (not shown) of the motor 10 and a hollow spindle 140 extending from a central portion of the main body 120 away from the motor 10. The spindle 140 comprises an inner wall 142 with screw threads formed thereon, an outer wall 144, and an end face 146. An axial hole 148 is enclosed by the inner wall 142. The spindle 140 is tapered from the central portion of the main body 120 to the end face 146.

The color filter unit 16 comprises a bracket 160, a metal ring 172, and a color filter 174 sandwiched between the bracket 160 and the metal ring 172. The bracket 160 is fittingly sleeved around the spindle 140. The bracket 160 comprises a sleeve 162 seated in a central hole (not labeled) defined in the color filter 174, and a brim 164 extending perpendicularly from an end of the sleeve 162. The brim 164 cooperates with the metal ring 172 to firmly hold the color filter 174 therebetween. The bracket 160 defines a funnel-shaped opening 166 through the sleeve 162 and the brim 164. The funnel-shaped opening 166 of the bracket 160 is shaped similar as the outer wall 144 but smaller than the spindle 140 so that the spindle 140 may be partially fittingly received in the funnel-shaped opening 166 of the bracket 160 in the embodiment. Thus, a long period of firm engagement of the bracket 160 and the spindle 140, because of insertion of a larger portion of the spindle 140 into the funnel-shaped opening 166 can be achieved.

The fixing member 18 is a bolt in the embodiment. The bolt 18 comprises a head 182 pressing on the metal ring 172 and a shank 184 extending from the head 182. The shank 184 forms screw threads thereon. The shank 184 is inserted into the axial hole 148 and screwed into the inner wall 142 of the spindle 140.

In assembly of the color wheel, the carrier 12 is fixed to the motor 10; the bracket 160 of the color filter unit 16 is sleeved around the spindle 140 of the carrier 12, by engagement of the tapered spindle 140 into the funnel-shaped opening 166 of the bracket 160; and finally the shank 184 of the fixing member 18 is screwed into the axial hole 148 of the spindle 140 until the head 184 of the fixing member 18 presses the color filter unit 16 toward the carrier 12. At this time, the color filter 174 is firmly held between the metal ring 172 and the brim 164 and the color filter unit 16 is firmly positioned to the carrier 12 by a fitting engagement of the tapered spindle 140 in the funnel-shaped opening 166 of the bracket 160. The engagement of the tapered spindle 140 in the funnel-shaped opening 166 of the bracket 160 results in a precise assembly of the color wheel and ensures a balanced rotation of the color wheel.

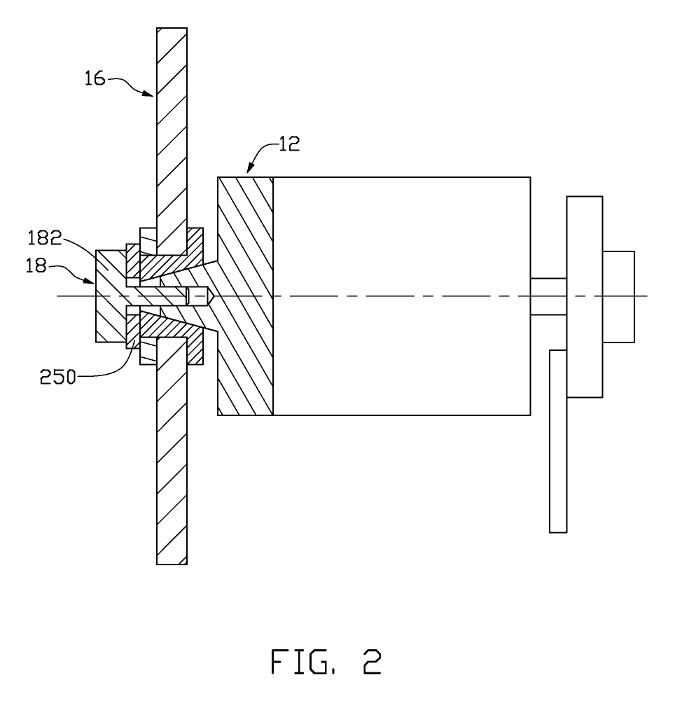

Referring to FIG. 2, a color wheel in accordance with a second present embodiment is illustrated. A difference of the color wheel of the second embodiment from the color wheel of the first embodiment is that an elastic member 250 is compressed between the head 182 of the fixing member 18 and the color filter unit 16, for urging the color filter unit 16 toward the carrier 12. In the embodiment, the elastic member 250 is annular.

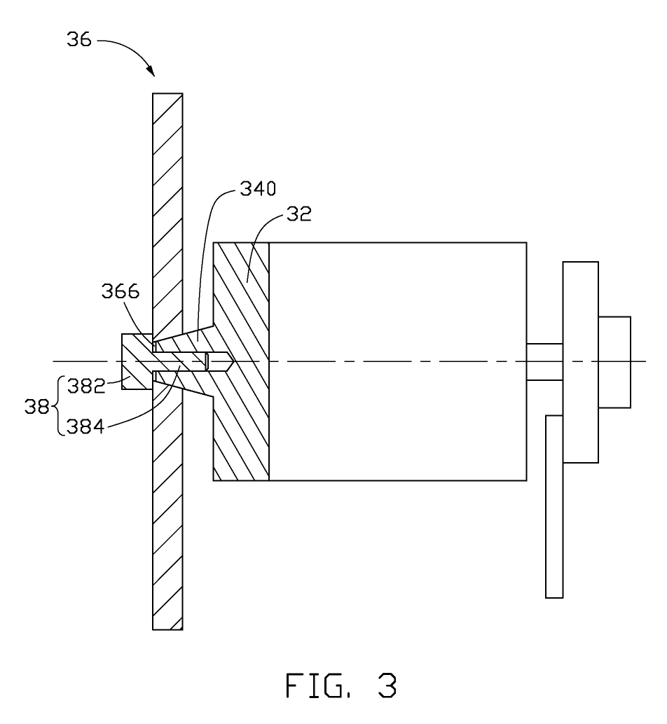

Referring to FIG. 3, a color wheel in accordance with a third present embodiment is illustrated. In the color wheel of the embodiment, a color filter unit 36 without the metal ring and bracket defines a funnel-shaped opening 366 in a central portion of the color filter unit 36. The spindle 340 having a tapered shape is partially received in the funnel-shaped opening 366 and threadedly engaged with a shank 384 of a fixing member 38. The fixing member 38 further comprises a head 382 pressing on the color filter unit 36 toward the carrier 32. Other features of the color wheel of the third embodiment can be referenced from a description of the first embodiment.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A color wheel comprising:
a motor;
a carrier comprising a main body fixed to the motor and a tapered spindle extending from the main body and away from the motor, the tapered spindle defining an axial hole therein;
a color filter unit defining an opening at a central portion thereof, the opening being shaped as but smaller than the tapered spindle and receiving a portion of the tapered spindle; and
a fixing member comprising a head pressing on the color filter unit and a shank extending from the head, the shank being engaged in the axial hole of the tapered spindle.

2. The color wheel as claimed in claim 1, wherein the color filter unit comprises a color filter, and wherein the head of the fixing member presses the color filter.

3. The color wheel as claimed in claim 2, wherein the opening is defined at a central portion of the color filter.

4. The color wheel as claimed in claim 1, wherein the color filter unit comprises a color filter and a bracket, the bracket being sleeved around the tapered spindle and holding the color filter.

5. The color wheel as claimed in claim 4, wherein the bracket comprises a sleeve seated at a central portion of the color filter and a brim extending perpendicularly from an end of the sleeve.

6. The color wheel as claimed in claim 5, wherein the color filter unit further comprises a metal ring cooperating with the bracket to hold the color filter therebetween, and wherein the head of the fixing member presses the metal ring.

7. The color wheel as claimed in claim 5, wherein the opening is defined in the bracket through the sleeve and the brim.

8. The color wheel as claimed in claim 1, further comprising an elastic member compressed between the head and the color filter unit, for urging the color filter unit toward the carrier.

9. The color wheel as claimed in claim 8, wherein the elastic member is annular.

10. The color wheel as claimed in claim 1, wherein the tapered spindle comprises an inner wall enclosing the axial hole, an outer wall fittingly engaging with the color filter unit and an end face, and wherein the tapered spindle is tapered from the main body to the end face.

11. The color wheel as claimed in claim 10, wherein the inner wall of the tapered spindle is threadedly engaged with the shank of the fixing member.
